(19) United States
(12) Patent Application Publication
(10) Pub. No.: US 2026/0329597 A1
(43) Pub. Date: Oct. 22, 2026

(54) LAYOUT CHANGING DEVICE, LAYOUT CHANGING METHOD, AND PROGRAM

(71) Applicant: NTT TechnoCross Corporation, Tokyo (JP)

(72) Inventors: Takashi AOKI, Tokyo (JP); Hosana KAMIYAMA, Tokyo (JP); Kenichi MACHIDA, Tokyo (JP)

(73) Assignee: NTT TechnoCross Corporation, Tokyo (JP)

(21) Appl. No.: 19/113,330

(22) PCT Filed: Oct. 6, 2022
(86) PCT No.: PCT/JP2022/037410

§ 371 Date: Mar. 19, 2025

(51) Int. Cl. G06F 9/451

(52) U.S. Cl. CPC G06F 9/451

(57) ABSTRACT

A layout changing device according to an aspect of the present disclosure includes a determination unit configured to determine, based on at least one of attributes of a user who performs a response by telephone to a customer or call contents of the telephone, whether or not to change a layout of a screen displayed on a terminal utilized by the user; and a generation unit configured to generate, in response to determination to change the layout, the screen with the layout in accordance with at least one of the attributes or the call contents.

### TECHNICAL FIELD

The present disclosure relates to a layout changing device, a layout changing method, and a program.

### BACKGROUND ART

Techniques of supporting operators' responses by telephone at contact centers (also referred to as call centers) are known (e.g., Non-Patent Document 1). Such techniques provide operators with a UI (user interface) referred to as a response support screen (hereinafter also referred to simply as a “support screen”) or the like in order for the operators to utilize various functions. The functions that are utilizable by operators on the support screen are, for example, a function of displaying texts representing contents of a call, a function of displaying customer information, a knowledge providing function, such as FAQs or the like, and a function of summarizing contents of a call.

### RELATED ART DOCUMENTS

### Non-Patent Documents

Non-Patent Document 1: ForeSight Voice Mining, Internet <URL: https://www. ntt-tx.co.jp/products/foresight_vm/>

### SUMMARY OF THE INVENTION

### Problem to be Solved by the Invention

However, not all functions are necessarily utilized, and depending on the skills of an operator or the contents of a call, some functions are not utilized at all. For example, it is considered that experienced operators often do not use the knowledge providing function because they have enough knowledge and experience. Also, it is considered that, when contents of a call are inquiries easy to answer, the knowledge providing function is often not utilized.

While the availability of various utilizable functions can contribute to supporting the operators' response tasks, it can also lead to information overload, potentially causing the utilization of incorrect functions or hesitation about which function to use. Especially, when an operator is an inexperienced one or the like, the possibility of such issues is expected to be high.

Therefore, preferably, the functions utilizable on the support screen can be flexibly changed in accordance with an operator, contents of a call, or the like.

The present disclosure has been made in view of the above, and it is an object of the present disclosure to provide a technique that can flexibly change support functions utilizable on the UI.

### Means for Solving the Problem

A layout changing device according to an aspect of the present disclosure comprises: a determination unit configured to determine, based on at least one of attributes of a user who performs a response by telephone to a customer or call contents of the telephone, whether or not to change a layout of a screen displayed on a terminal utilized by the user; and a generation unit configured to generate, in response to determination to change the layout, the screen with the layout in accordance with at least one of the attributes or the call contents.

### Advantageous Effects of the Invention

A technique that can flexibly change support functions utilizable on a UI is provided.

### BRIEF DESCRIPTION OF THE DRAWINGS

FIG. 1 is a diagram illustrating an example of an entire configuration of a contact center system according to the present embodiment.

FIG. 2 is a diagram illustrating an example of a support screen with a default layout.

FIG. 3 is a diagram illustrating an example of a functional configuration of a response support system and an operator terminal according to the present embodiment.

FIG. 4 is a flowchart illustrating an example of a support screen display process according to the present embodiment.

FIG. 5 is a diagram illustrating an example of a support screen after layout change (Part 1).

FIG. 6 is a diagram illustrating an example of a support screen after layout change (Part 2).

FIG. 7 is a diagram illustrating an example of a support screen after layout change (Part 3).

FIG. 8 is a diagram illustrating an example of a support screen after layout change (Part 4).

FIG. 9 is a diagram illustrating an example of a support screen after layout change (Part 5).

### EMBODIMENTS FOR CARRYING OUT THE INVENTION

Hereinafter, embodiments of the present invention will be described. The embodiments are intended for contact centers, specifically, a contact center system 1 in which operators can flexibly change support functions utilizable on support screens. However, the contact center is merely an example, and is by no means a limitation. For example, the embodiments are intended for offices or the like, and are similarly applicable when a person who performs responses to customers flexibly changes support functions utilizable on a UI (user interface). In general, the embodiments are similarly applicable when flexibly changing, in accordance with some conditions, functions for supporting someone's tasks that are utilizable on a UI.

### Entire Configuration Example of the contact center system 1

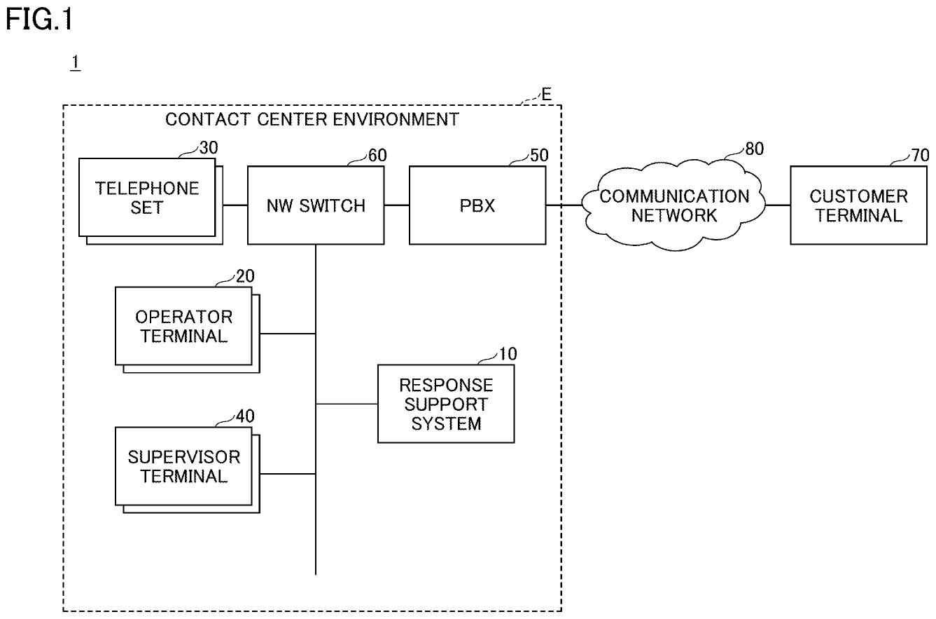

FIG. 1 is a diagram illustrating an example of the entire configuration of the contact center system 1 according to the present embodiment. As illustrated in FIG. 1, the contact center system 1 according to the present embodiment includes a response support system 10, a plurality of operator terminals 20, a plurality of telephone sets 30, one or more supervisor terminals 40, a PBX (Private Branch exchange) 50, a NW switch 60, and a customer terminal 70. Here, the response support system 10, the operator terminal 20, the telephone sets 30, supervisor terminals 40, the PBX 50, and the NW switch 60 are installed in a contact center environment E, which is a system environment of the contact center. The contact center environment E is not limited to a system environment in the same building, but may be, for example, system environments in a plurality of geographically separated buildings.

The response support system 10 is a server, a group of servers, or the like, configured to provide various functions for supporting the operators' responses by telephone (support functions). The support functions provided by the response support system 10 are various, but in the present embodiment, the response support system 10 can provide at least the following support functions (1) to (9).
(1) Call text providing function: This function is a function of creating call texts through conversion of voice calls between an operator and a customer into time information-annotated texts for each speaker by using packets (voice packets) transmitted from the NW switch 60, thereby providing the call texts in time series for each speaker. This function enables an operator to confirm customer's utterances and his/her utterances in real time during a call.
(2) Knowledge providing function: This function is a function of providing knowledge, such as FAQs and the like. This function enables an operator to confirm necessary procedures and the like in the format of FAQs.
(3) Important matter providing function: This function is a function of providing matters that an operator needs to explain to a customer or for which an operator needs to confirm with a customer (such matters are also referred to as “important matters”). This function enables an operator to know what matters to explain to a customer, and what matters to confirm with a customer.
(4) Chat function: This function is a function of providing transmission and reception of messages with a supervisor or the like (what is referred to as a chat). For example, this function enables an operator to ask a supervisor for inquiry or support. The supervisor refers to, for example, a person who monitors operators' calls, and supports operators' responses by telephone when some problems are likely to occur or in accordance with requests by the operators.
(5) Support request function: This function is a function of requesting support from a supervisor or the like. This function enables an operator to request support from a supervisor or the like, for example, when some problems have occurred or are likely to occur.
(6) Customer information providing function: This function is a function of providing information of a customer that an operator is currently responding to (e.g., attribute information, such as his/her name, age, gender, address, history of purchase of goods and services, and the like). This function enables an operator to know various information of a customer that the operator is currently responding to.
(7) Memo function: This function is a function of allowing an operator to create a memo as desired. This function enables an operator to, for example, leave contents the operator wishes to keep, as a memo (customer interaction record memo).
(8) Previous call summary providing function: This function is a function of providing a summary of a previous call with a customer that an operator is currently responding to. This function enables an operator to confirm a summary text in which the previous call with the customer is summarized.
(9) Call summarizing function: This function is a function of creating a summary text in which call contents are summarized by using call texts. This function enables an operator to, for example, know a summary of a call after the end of the call, or confirm a summary of a previous call by the previous call summary providing function when the operator receives a call from the same customer again.

The above (1) to (9) are merely examples. In addition to these, the response support system 10 may provide various functions. For example, the response support system 10 may provide all or some of the following functions (10) to (14).
(10) Call text analyzing function: This function is a function of, by analyzing call texts, identifying a call reason (a reason for receiving a call) or a situation (a state) of a call, or identifying whether the call is inbound or outbound. This function enables an operator to know a call reason or a situation of a customer that the operator is currently responding to. Also, for example, the important matter providing function can provide important matters in accordance with the call reason, the situation, and whether the call is inbound or outbound. Examples of the situation include initial greeting (opening), inquiry confirmation, customer identification, a response, final greeting (closing), and the like.
(11) Call history storing function: This function is a function of storing, for example, information of an operator who responded to a call, information of a customer of the call, and call texts, a summary text, and the like of the call, as call history information. This function enables, for example, utilization of call history information for analysis of response quality and evaluation of operators.
(12) Search function: This function is a function of searching the call history information stored by the call history storing function, and providing search results to an operator, a supervisor, or the like. This function enables an operator, a supervisor, and the like to search the call history information in accordance with desired search conditions, and refer to the call history information obtained as the search results.
(13) Call monitoring function: This function is a function of providing information for a supervisor to monitor calls of operators (e.g., call texts of their calls, inappropriate language included in the call texts, and the like). This function enables a supervisor to efficiently monitor calls of operators that the supervisor needs to monitor. In general, calls of several to a dozen operators are monitored by one supervisor.
(14) Analysis function: This function is a function of performing various analyses (e.g., analysis of response quality or the like) by using the call history information stored by the call history storing function. This function enables a person who wishes to provide calls of quality response (e.g., analyzers for response quality, supervisors, and the like) to analyze response quality and consider various measures and countermeasures for improving the response quality.

The above (10) to (14) above are merely examples.

The operator terminal 20 is a terminal used by an operator, such as a PC (personal computer) or the like.

The telephone set 30 is an IP (Internet Protocol) telephone set used by an operator (e.g., a landline IP telephone set, a portable IP telephone set, or the like).

The supervisor terminal 40 is a terminal used by a supervisor, such as a PC or the like.

The PBX 50 is a telephone exchange (IP-PBX) and is connected to a communication network 80 including a VoIP (Voice over Internet Protocol) network and a PSTN (Public Switched Telephone Network)

The NW switch 60 relays packets (voice packets) between the telephone set 30 and the PBX 50, and captures the packets and transmits the captured packets to the response support system 10.

The customer terminal 70 is various terminals used by a customer, such as a smartphone, a mobile phone, a landline telephone, and the like.

The entire configuration of the contact center system 1 illustrated in FIG. 1 is merely an example, and is by no means a limitation. Other configurations may be possible. For example, in the example illustrated in FIG. 1, the response support system 10 is included in the contact center environment E (i.e., the response support system 10 is of an on-premise type). However, all or a part of the functions of the response support system 10 may be realized by a cloud service or the like. Similarly, in the example illustrated in FIG. 1, the PBX 50 is a telephone exchange of an on-premise type, but may be realized by a cloud service. When the operator terminal 20 has a telephone function, the contact center system 1 need not necessarily include the telephone sets 30.

### Example of Support Screen with Default Layout

All or some of the support functions provided by the response support system 10 can be utilized by an operator on the support screen displayed on the operator terminal 20. This support screen is continuously displayed on the operator terminal 20 not only during a response by telephone with a customer but also, for example, after the response by telephone. This is because, for example, the operator often refers to the support screen for performing an after call task referred to as ACW (After Call Work) or the like (e.g., issue of slips of products).

Some of the support functions may not be utilizable by the operator, but may be utilizable only by the supervisor or other users (i.e., utilization of some of the support functions may be limited by means of user authorization or the like). For example, the call monitoring function is a support function that is utilizable only by the supervisor, and is an example of the support functions that are not utilizable by the operator.

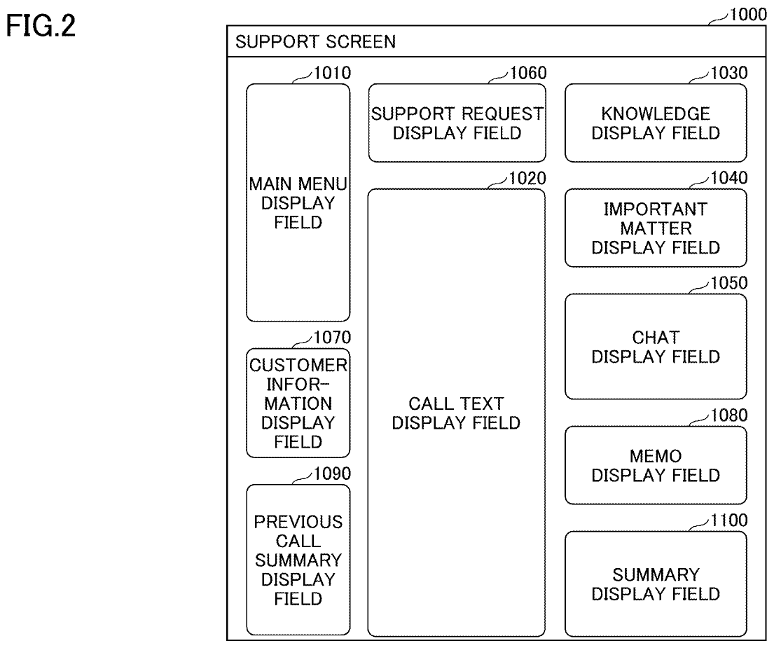

The following will be described assuming a support screen 1000 with a layout illustrated in FIG. 2 as a standard layout (default layout) of the support screen displayed on the operator terminal 20 of the operator who is performing a response by telephone.

In the support screen 1000 with this default layout, the operator can utilize all the support functions that the operator can utilize. The support screen 1000 illustrated in FIG. 2 includes a main menu display field 1010, a call text display field 1020, a knowledge display field 1030, an important matter display field 1040, a chat display field 1050, a support request display field 1060, a customer information display field 1070, a memo display field 1080, a previous call summary display field 1090, and a summary display field 1100.

Various menu buttons for displaying screens other than the support screen are displayed in the main menu display field 1010. For example, a menu button for displaying a screen in which the call text analyzing function is utilizable, a menu button for displaying a screen in which the search function is utilizable, a menu button for displaying a screen in which the analysis function is utilizable, and the like are displayed in the main menu display field 1010.

In the call text display field 1020, call texts representing utterances of a customer and an operator are displayed in time series by the call text providing function. Especially, during a call between a customer and an operator, call texts of the call are displayed in real time in the call text display field 1020. In the call text display field 1020, for example, the call texts corresponding to important matters displayed in the important matter display field 1040 may be highlighted (e.g., displayed in a highlighting manner, a blinking manner, and the like) or may be displayed in a manner different from manners in which other call texts are displayed.

In the knowledge display field 1030, knowledge, such as FAQs or the like, is displayed by the knowledge providing function. The knowledge is not limited to FAQs, and can include useful information for an operator to perform a response task (e.g., recommendation information or the like that recommends something).

In the important matter display field 1040, important matters are displayed by the important matter providing function. In the important matter display field 1040, important matters alone may be displayed, or a talk script or the like including important matters may be displayed.

In the chat display field 1050, chat messages with a supervisor and the like are displayed by the chat function.

In the support request display field 1060, a button or the like for requesting support from a supervisor or the like is displayed by the support request function.

In the customer information display field 1070, customer information is displayed by the customer information providing function. This customer information is obtained from a system, such as CRM (Customer Relationship Management), IVR (Interactive Voice Response), or the like.

In the memo display field 1080, memos created by the memo function are displayed. An operator can create a memo by inputting desired characters or symbols to the memo display field 1080, or attaching a desired image or the like to the memo display field 1080.

In the previous call summary display field 1090, a summary text of a previous call with a customer that an operator is currently responding to, by the previous call summary providing function.

In the summary display field 1100, a summary text of a call after the end of the call is displayed by the call summarizing function.

In this manner, on the support screen 1000 with the default layout, all the support functions utilizable by an operator are displayed regardless of operator's attributes, call contents, or the like. As a result, for example, support functions unnecessary for an experienced operator (e.g., the knowledge providing function, the chat function, and the like) are displayed, or too much information is provided to an inexperienced operator. Also, there are support functions that are unnecessary in accordance with call contents, e.g., display of customer information is unnecessary for internal calls.

Therefore, the following describes a case in which a condition (hereinafter also referred to as a layout change condition) is set in accordance with operator's attributes, call contents, or the like, and when this condition is satisfied, the support screen is changed to a layout in accordance with the condition.

### Functional Configuration Example of the Response Support System 10 and the Operator Terminal 20

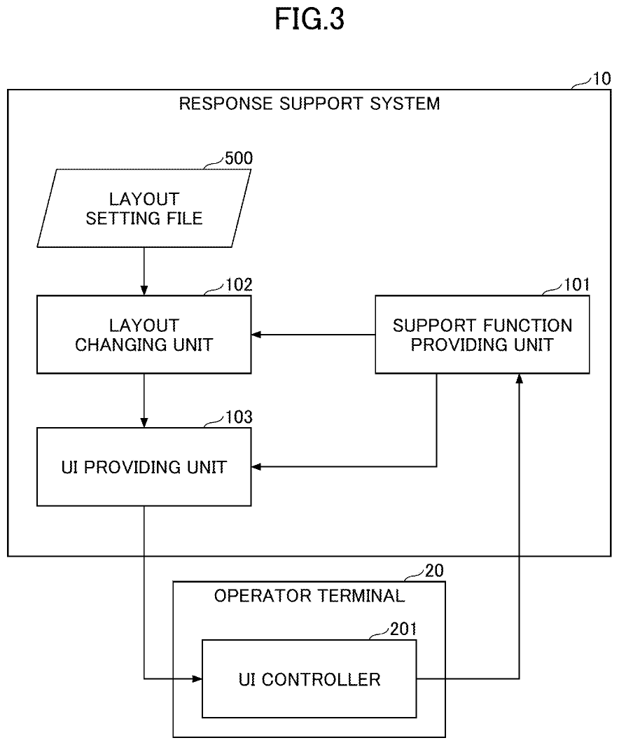

FIG. 3 is a diagram illustrating a functional configuration example of the response support system 10 and the operator terminal 20 according to the present embodiment.

### Response Support System 10

As illustrated in FIG. 3, the response support system 10 according to the present embodiment includes a support function providing unit 101, a layout changing unit 102, and a UI providing unit 103. Each of these units is realized, for example, through a process performed by a processor, such as a CPU (Central Processing Unit) or the like, that is executed in accordance with one or more programs installed in the response support system 10.

The support function providing unit 101 is configured to provide various support functions (e.g., the above support functions (1) to (14)).

The layout changing unit 102 is configured to refer to the layout setting file 500, and in response to determination that a layout change condition is satisfied, instruct the UI providing unit 103 to change the layout of the support screen. Here, the layout setting file 500 refers to data in which layout change conditions are associated with layout change information indicating contents of layout changes to be performed when the layout change conditions are satisfied. Specific examples of the layout change conditions and the layout change information will be described below. The layout setting file 500 is stored in a storage area of a storage, such as an HDD (Hard Disk Drive), an SSD (Solid State Drive), a flash memory, or the like.

The UI providing unit 103 is configured to provide a support screen to the operator terminal 20. That is, the UI providing unit 103 generates a support screen, and displays the generated support screen on the display of the operator terminal 20. When layout change is instructed by the layout changing unit 102, the UI providing unit 103 generates a support screen with a layout after the change. Otherwise, the UI providing unit 103 generates a support screen with the default layout. The support screen is expressed by information, such as HTML (Hypertext Markup Language), CSS (Cascading Style Sheets), JavaScript, or the like.

Although not illustrated in the example illustrated in FIG. 3, the response support system 10 includes various DBs (databases) and other functional units that are utilized to realize various support functions. For example, the response support system 10 includes an operator information DB that stores operators' information including operators' ID and attributes (operators' names, operators' departments, and the like), a call history DB that stores call history information, and the like.

### Operator Terminal 20

As illustrated in FIG. 3, the operator terminal 20 according to the present embodiment includes a UI controller 201. The UI controller 201 is realized, for example, through a process performed by a processor, such as a CPU or the like, that is executed in accordance with one or more programs (e.g., a Web browser or the like) installed in the operator terminal 20.

The UI controller 201 is configured to display, on a display, a support screen provided from the response support system 10. Also, the UI controller 201 receives various input operations performed by an operator on the support screen (e.g., pressing operations of buttons, input operations of characters, and the like).

### Layout Setting File 500

The following describes some specific examples of the layout change conditions and the layout change information included in the layout setting file 500. In the following, the layout change includes not only making a change to display or hide a display field included in the support screen, or changing the arrangement of a display field, but also changing a display mode of the display field (e.g., highlighting the display field or changing the color of the display field).
Specific example 1 of the layout change condition and the layout change information

It is generally considered that, when an operator is an experienced one, this operator does not utilize the knowledge providing function or the chat function because the operator has enough knowledge and experience. Therefore, it is considered that, when an operator is an experienced one, the knowledge display field and the chat display field are hidden. In this case, the layout change condition and the corresponding layout change information can be set as follows.
Layout change condition=“Operator is experienced one”

Layout change information=“Knowledge display field is hidden” and “Chat display field is hidden” Whether or not an operator is an experienced one can be determined, for example, in accordance with the operator information. For example, if a flag indicating whether or not an operator is an experienced one is included in the operator information, whether or not the operator is an experienced one may be determined from the value of the flag. Alternatively, for example, if the operator information of experienced operators is grouped, whether or not the operator is an experienced one can be determined in accordance with whether or not the operator information of the operator of interest belongs to the group. In addition to the above, for example, if the attributes of the operator information include years of service, whether or not the operator is an experienced one can be determined in accordance with the years of service.
Specific example 2 of the layout change condition and the layout change information

For sales calls (outbound) in which operators mainly make a call to new customers, there is often a lack of existing customer information or previous call summaries. Therefore, it is considered that, when a call is outbound, the customer information display field and the previous call summary display field are hidden. In this case, the layout change condition and the corresponding layout change information can be set as follows.
Layout change condition=“Outbound” Layout change information=“Hide customer information display field” and “Hide previous call summary display field”

Whether or not a call is outbound can be determined, for example, in accordance with analysis results obtained by the call text analyzing function (i. e., analysis results identifying whether the call of interest is inbound or outbound).
Specific example 3 of the layout change condition and the layout change information

Even experienced operators may request support from a supervisor when they receive complaints from a customer or when events likely to lead to complaints have occurred. Therefore, even if the knowledge display field and the chat display field are hidden, it is preferable to re-display at least the chat display field in response to detecting complaints or events likely to lead to complaints. In this case, the layout change condition and the corresponding layout change information may be set as follows.

Layout change condition=“Specific word detected”
Layout change information=“Display chat display field”

Here, the specific word is a word indicating the occurrence of complaints, or a word, a phrase, or the like likely to lead to the occurrence of complaints (i.e., what is referred to as inappropriate language, inappropriate phrase, or the like). A set of such specific words is pre-defined, and stored in a DB or the like. Specific examples of the specific words include “Call your manager”, “Call your boss”, and the like. Detection of the specific word is realized, for example, by the call monitoring function.

In addition to the above, for example, detection of a specific word, such as “I called you before” may be used as the layout change condition, and “Display previous call summary display field” may be used as the layout change information.
Specific example 4 of the layout change condition and the layout change information It is considered that, for internal calls for communications within the company and the like, customer information, previous call summary, knowledge, important matters, and the like are unnecessary. Therefore, it is considered that, for internal calls, the customer information display field, the previous call summary display field, the knowledge display field, and the important matter display field are hidden. In this case, the layout change condition and the corresponding layout change information may be set as follows.

Layout change condition=“Internal call” Layout change information=“Hide chat display field”, “Hide previous call summary display field”, “Hide knowledge display field”, and “Hide important matter display field”

Whether or not a call is an internal one can be determined, for example, in accordance with an incoming/outgoing telephone number included in packets forwarded from the NW switch 60.
Specific example 5 of the layout change condition and the layout change information When a situation during a call becomes a specific situation, there may be a case in which specific contents should be confirmed. For example, when a situation during a call is “customer identification”, it is necessary to refer to customer information, and confirm whether or not the name, address, and the like, provided by the customer, are correct. Therefore, when the situation becomes a specific situation, it is preferable to highlight a specific display field.

This is especially effective when an operator is an inexperienced one, or lacks experience or knowledge.

In this case, the layout change condition and the corresponding layout change information may be set as follows.
Layout change condition=“Specific situation”
Layout change information=“Highlight specific display field”

Here, the specific situation refers to a specific state, a specific call reason, or the like. The state or the call reason may be determined, for example, by the call text analyzing function.

The specific situation may include, for example, a customer's situation. As a specific example, assuming a response to an inquiry of a procedure of an insurance, the customer's situation may be whether the customer is a victim in an accident or an offender who caused the accident.

By, for example, pre-defining an “inquiry from the victim” and an “inquiry from the offender” as states, such a customer's situation can be determined by the call text analyzing function.

Other examples of the customer information include, for example, whether or not an accident applicable to an insurance has occurred.

Specific examples 1 to 6 of the layout change condition and the layout change information are merely examples, and are by no means limitations. The layout change condition may be various conditions derived from attributes of an operator and call contents, and the layout change information may be information indicating contents of change to a better layout under an index when the layout change condition is satisfied. For example, specific examples of the operator's attributes that are usable as the layout change condition include whether an operator is an experienced one or an inexperienced one, an operator's incoming number, an operator's gender, an operator's department, years of experience, a job title, whether or not the operator is a remote worker, whether or not the operator uses a free address system, and the like.

Specific examples of the call contents that are usable as the layout change condition include a call reason, a state, inbound/outbound, internal/external, customer information (e.g., a telephone number, contents of a previous response, and the like), detection of a specific word, a call start time, a duration from the start of a call, and the like.

The layout setting file 500 may include a plurality of layout change conditions and layout change information corresponding to the respective layout change conditions. For example, when the n^{th} layout change condition is described as “layout change condition n” and the corresponding layout change information is described as “layout change information n”, the layout setting file 500 may be expressed as {(Layout change condition n, Layout change information n) |n=1, . . . , N}. N is the number of layout change conditions and the corresponding number of pieces of layout change information included in the layout setting file 500.

### Support Screen Display Process

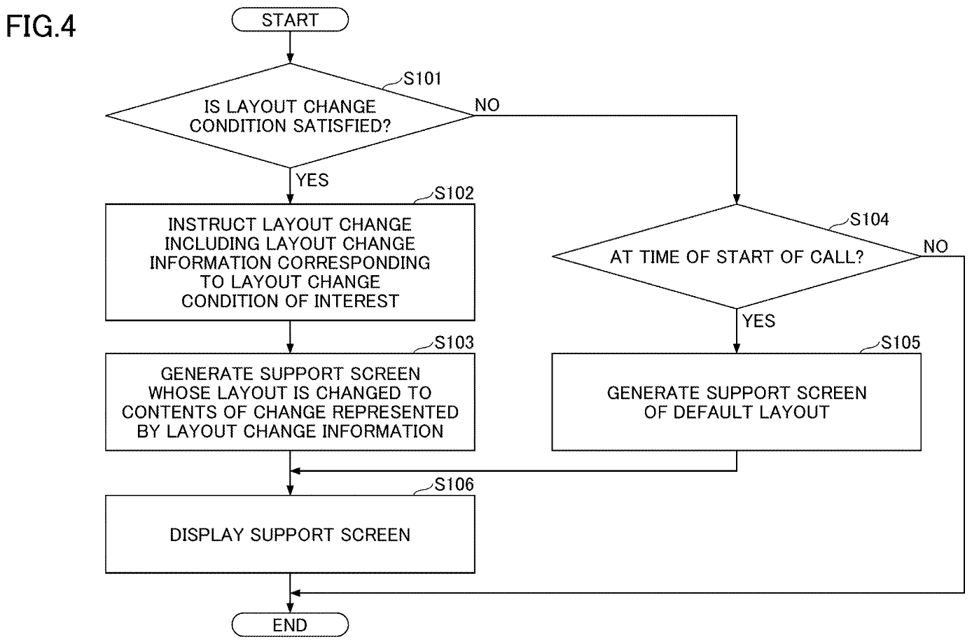

In the following, a support screen display process according to the present embodiment will be described with reference to FIG. 4. For example, the following support screen display process may be performed on the operator terminal 20 at the start of a call with a customer, or repeatedly performed in real time during a call with a customer. The following describes a case in which a support screen (including a support screen after layout change) is displayed on the display of the operator terminal 20 at the start of a call or in real time during a call.

The layout changing unit 102 refers to the layout setting file 500, and determines whether or not a layout change condition is satisfied (step S101). In other words, the layout changing unit 102 determines whether or not the layout change conditions included in the layout setting file 500 include a layout change condition that satisfies a predetermined condition.

If it is determined in step S101 that the layout change condition is satisfied, the layout changing unit 102 instructs the UI providing unit 103 to perform layout change including the layout change information corresponding to the layout change condition (step S102).

Next, the UI providing unit 103 generates a support screen in which the layout is changed to contents of change indicated by the layout change information included in the instructions from the layout changing unit 102 (step S103). Thus, the support screen after the layout change is generated.

If it is not determined in step S101 that the layout change condition is satisfied, the UI providing unit 103 determines whether or not a call is at the time of start (step S104).

If it is determined in step S104 that a call is at the time of start, the UI providing unit 103 generates a support screen with a default layout (step S105). If it is not determined in step S104 that a call is at the time of start (i.e., a call is underway), the UI providing unit 103 does nothing.

This is because, when a call is underway, a support screen with a layout is already displayed on the display of the operator terminal 20.

Following step S103 or step S105, the UI providing unit 103 displays, on the display of the operator terminal 20, the support screen after the layout change or the support screen with the default layout (step S106). That is, if the support screen after the layout change is generated in step S103, the UI providing unit 103 displays this support screen on the display of the operator terminal 20, while if the support screen with the default layout is generated in step S105, the UI providing unit 103 displays this support screen on the display of the operator terminal 20. Thus, the support screen after the layout change or the support screen with the default layout is displayed on the display of the operator terminal 20. In order to display the support screen on the display of the operator terminal 20, the UI providing unit 103 may transmit information indicating the support screen to the operator terminal 20.

### Example of Support Screen After Layout Change

Some specific examples of the support screen after the layout change will be described below.
Specific example 1 of the support screen after the layout change

The following layout change condition and layout change information are associated with each other in the layout setting file 500.

Layout change condition=“Operator is experienced one”

Layout change information=“Hide knowledge display field” and “Hide chat display field”

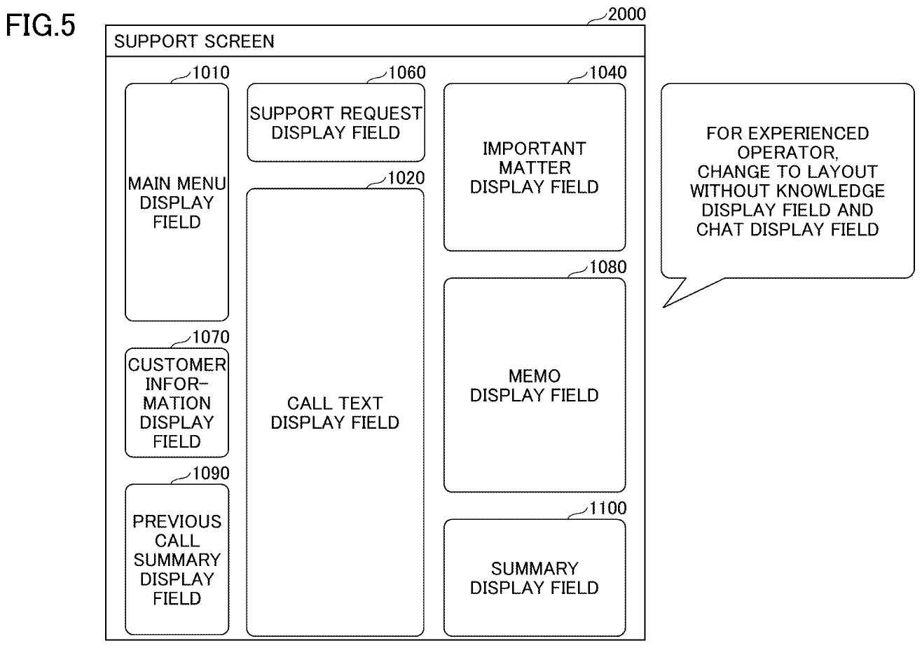

FIG. 5 illustrates a support screen 2000 in which the layout is changed from the default layout when the layout change condition is satisfied. In the support screen 2000 illustrated in FIG. 5, the knowledge display field 1030 and the chat display field 1050 are not displayed. This is because it is generally considered that, when an operator is an experienced one, the operator has enough knowledge and experience and thus does not utilize the knowledge providing function or the chat function.
Specific example 2 of the support screen after the layout change

The following layout change condition and layout change information are associated with each other in the layout setting file 500.

Layout change condition=“Outbound” Layout change information=“Hide customer information display field” and “Hide previous call summary display field”

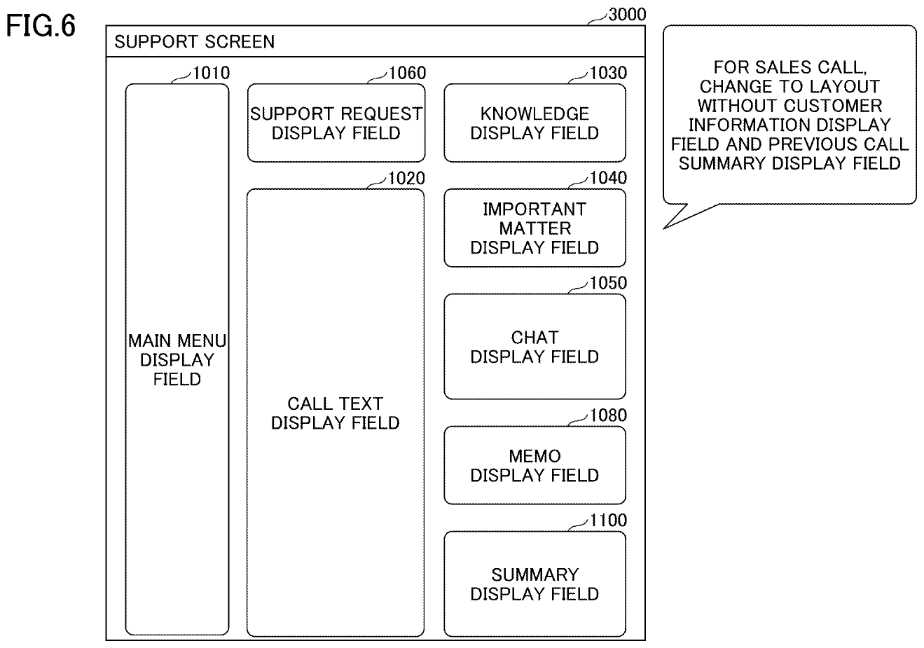

FIG. 6 illustrates a support screen 3000 in which the layout is changed from the default layout when the layout change condition is satisfied. In the support screen 3000 illustrated in FIG. 6, the customer information display field 1070 and the previous call summary display field 1090 are not displayed. This is because, for sales calls (outbound) in which operators mainly make a call to new customers, neither customer information or previous call summary often exists.
Specific example 3 of the support screen after the layout change

The following layout change condition and layout change information are associated with each other in the layout setting file 500.

Layout change condition=“Specific word detected” Layout change information=“Display chat display field”

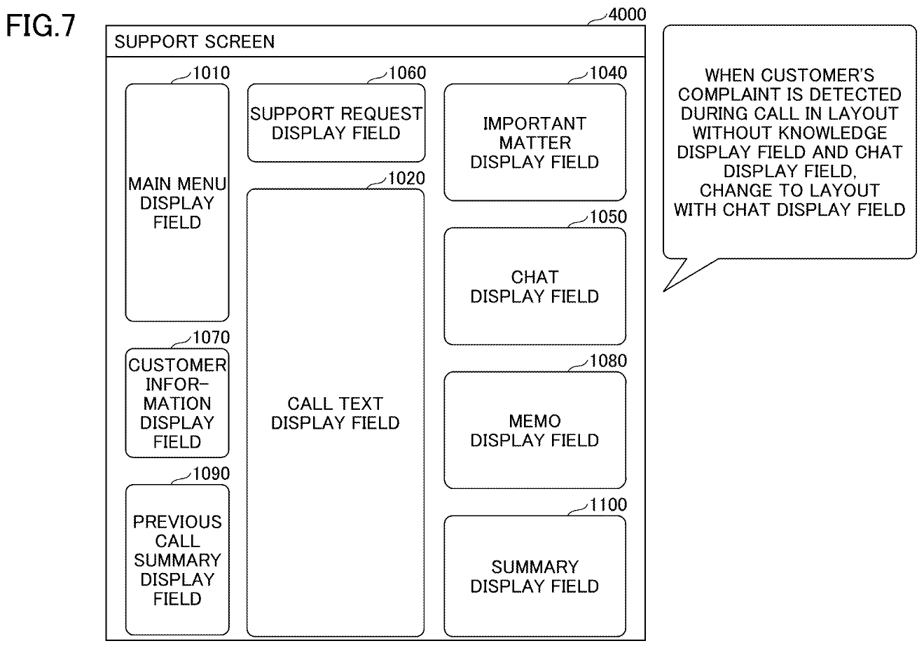

FIG. 7 illustrates a support screen 4000 in which the layout is changed from the layout of the support screen 2000 illustrated in FIG. 5 when the layout change condition is satisfied. In the support screen 4000 illustrated in FIG. 7, the chat display field 1050 is displayed again. This is because even an experienced operator may request support from a supervisor via a chat when the operator receives complaints from a customer or when an event likely to lead to complaints has occurred.
Specific example 4 of the support screen after the layout change

The following layout change condition and layout change information are associated with each other in the layout setting file 500.

Layout change condition=“Internal call” Layout change information=“Hide chat display field”, “Hide previous call summary display field”, “Hide knowledge display field”, and “Hide important matter display field”

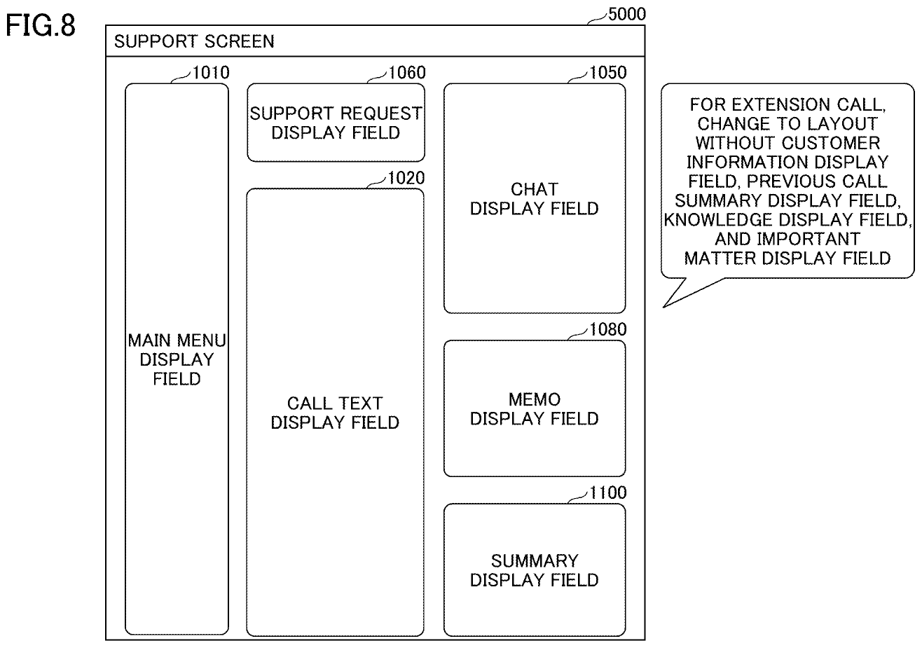

FIG. 8 illustrates a support screen 5000 in which the layout is changed from the default layout when the layout change condition is satisfied. In the support screen 5000 illustrated in FIG. 8, the knowledge display field 1030, the important matter display field 1040, the chat display field 1050, and the previous call summary display field 1090 are not displayed. This is because it is considered that, for internal calls for communications within the company and the like, customer information, previous call summary, knowledge, important matters, and the like are unnecessary.
Specific example 5 of the support screen after the layout change The following layout change condition and layout change information are associated with each other in the layout setting file 500.

Layout change condition=“Situation of customer identification” Layout change information=“Highlight customer information display field”

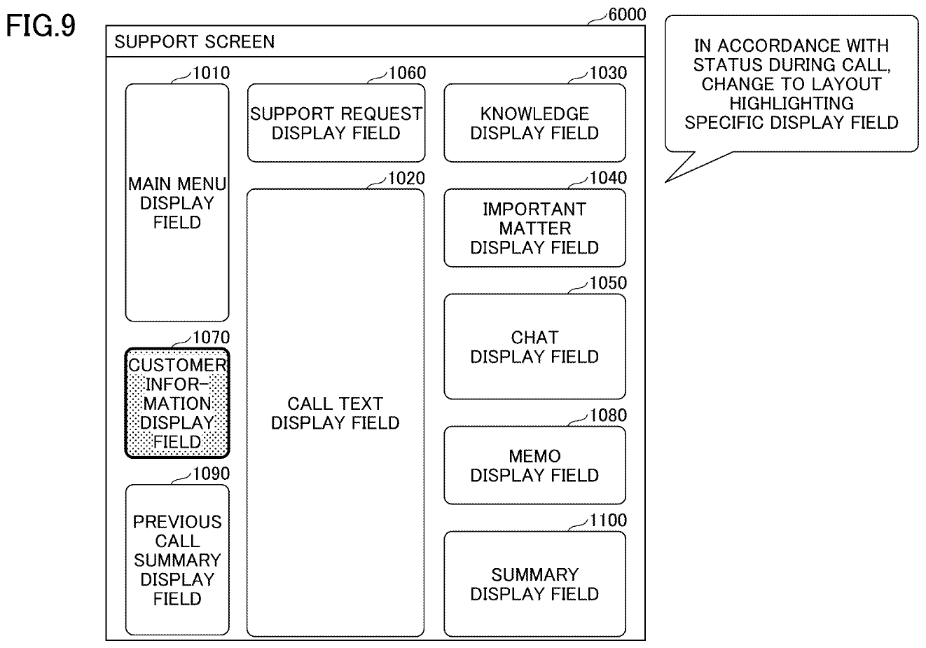

FIG. 9 illustrates a support screen 8000 in which the layout is changed from the default layout when the layout change condition is satisfied. In the support screen 8000 illustrated in FIG. 9, the customer information display field 1070 is highlighted. This is because, when a situation during a call is “customer identification”, it is necessary to refer to customer information displayed in the customer information display field 1070, and confirm whether or not the name, address, and the like, provided by the customer, are correct.

### Modified Examples

Hereinafter, some Modified Examples of the present embodiment will be described.

### Modified Example 1

In the above embodiments, the layout change conditions and the layout change information are associated with each other in the layout setting file 500. However, for example, layout information indicating a layout after change may be associated instead of the layout change information.

### Modified Example 2

In the above embodiments, the operator terminal 20 has a Web browser, and a support screen expressed by information, such as HTML, CSS, Javascript, or the like, is generated by the response support system 10. However, for example, the support screen may be generated by the operator terminal 20. In this case, for example, if it is determined that a layout change condition is satisfied, the response support system 10 may transmit, to the operator terminal 20, layout change information corresponding to the layout change condition, and the operator terminal 20 may change the layout of the support screen in accordance with the layout change information.

### Modified Example 3

In the above embodiments, the layout change conditions are determined both at the start of a call and during a call. However, for example, a layout change condition may be determined either at the start of a call or during a call.

In this case, for example, a flag for determination that takes three values, i.e., 0, 1, and 2 is associated with a layout change condition, and a combination of the following three: (Layout change condition, Layout change information, Flag for determination) may be included in the layout setting file 500. Here, for example, the flag for determination may take 0 when the layout change condition is determined only at the start of a call, 1 when the layout change condition is determined only during a call, and 2 when the layout change condition is determined both at the start of a call and during a call.

### Modified Example 4

There may be a case in which a plurality of layout change conditions are satisfied at the same time.

Thus, information indicating priority (or an order of priority) may be associated with the layout change conditions. For example, a combination of the following three: (Layout change condition, Layout change information, Priority) may be included in the layout setting file 500.

Thus, when a plurality of layout change conditions are satisfied at the same time, priority is given to the layout change condition with higher priority, and the layout of a support screen is changed in accordance with the layout change information associated with the layout change condition with higher priority.

Alternatively, when a plurality of layout change conditions are satisfied at the same time, the layout of a support screen may be sequentially changed in accordance with the layout change information corresponding to the layout change conditions in order of priority. Thus, for example, when the layout change information is to highlight a specific display field, the display fields are sequentially highlighted in order of priority.

Therefore, for example, when confirming a plurality of display fields, if the order of confirmation is important, highlighting can be performed taking into consideration the order of confirmation. This enables an inexperienced operator or the like to sequentially confirm the display fields in an appropriate order of confirmation.

### Modified Example 5

It may be found that a support screen with a specific layout is beneficial to an operator with specific attributes. For example, it may be found that a support screen with a specific layout is beneficial to an inexperienced operator, or is readily usable by an experienced operator. In such a case, the support screen with the specific layout may be used as a template, and, for example, may be used as a support screen with the default layout for an operator with the specific attributes.

### Modified Example 6

In the above embodiments, the layout change information is to display or hide a specific display field, or to change the display mode (e.g., highlighting or the like). This is by no means a limitation, and other contents of change are possible. For example, the layout position of a display field may be changed, the layout position may be exchanged between display fields, the size of a display field may be increased or decreased, or the like.

### SUMMARY

As described above, according to the contact center system 1 according to the present embodiment, the layout of a support screen displayed on the operator terminal 20 of an operator can be changed at the start of a call or in real time (dynamically) during a call, in accordance with operator's attributes and call contents. This enables an operator to perform a response to a call while referring to the support screen with a layout that is appropriate in accordance with the attributes of the operator and the contents of the call that the operator is currently responding to.

The present invention is not limited to the above specifically disclosed embodiments. Various modifications, alterations, combinations with existing techniques, and the like are possible without departing from the claims recited.

### REFERENCE SIGNS LIST

1 Contact center system
10 Response support system
20 Operator terminal
30 Telephone set
40 Supervisor terminal
50 PBX
60 NW switch
70 Customer terminal
80 Communication network
101 Support function providing unit
102 Layout changing unit
103 UI providing unit
201 UI controller
500 Layout setting file
E Contact center environment

1. A layout changing device, comprising:
a memory; and
at least one processor connected to the memory, wherein
the processor is configured to:
determine, based at least on information of a telephone call and a predetermined layout change condition, to cause a change to a layout of a screen displayed on a terminal utilized by a user, wherein the user performs conversation with a customer during the telephone call; and
generate, in response to the determined to cause the change to the layout, the screen with the layout in accordance with the information of the telephone call.

2. The layout changing device according to claim 1, further comprising:
a storage configured to store
the predetermined layout change condition based at least on the information of the telephone call,
wherein
the determining further comprises operations to:
determine the condition is satisfied based at least on the information of the telephone call,
determine to cause the change to the layout in response to the determined condition as satisfied, and
generate, in response to the determined to cause the change to the layout, the screen with the layout that is changed in accordance with the condition.

3. The layout changing device according to claim 2, wherein
the change to the layout comprises displaying a display field of a function that is utilizable on the screen.

4. (canceled)

5. A layout changing method executed by a computer, the layout changing method comprising:
determining, based at least on information of a telephone call and a predetermined layout change condition, to cause a change to a layout of a screen displayed on a terminal utilized by a user. wherein the user performs conversation with a customer during the telephone call; and
generating, in response to the determined to cause the change to the layout, the screen with the layout in accordance with the information of the telephone call.

6. A non-transitory computer-readable recording medium storing a program that causes a computer to execute:
determining, based at least on information of a telephone call and a predetermined layout change condition, to cause a change to a layout of a screen displayed on a terminal utilized by a user, wherein the user performs conversation with a customer during the telephone call; and
generating, in response to the determined to cause the change to the layout, the screen with the layout in accordance with the information of the telephone call.

7. The layout changing device according to claim 1, wherein the information of the telephone call comprises an attribute of the user, and the predetermined layout change condition specifies the attribute of the user.

8. The layout changing device according to claim 1, wherein the information of the telephone call comprises content of the telephone call, and the predetermined layout change condition specifies the content of the telephone call.

9. The layout changing method according to claim 5, wherein the information of the telephone call comprises an attribute of the user, and the predetermined layout change condition specifies the attribute of the user.

10. The layout changing method according to claim 5, wherein the information of the telephone call comprises content of the telephone call, and the predetermined layout change condition specifies the content of the telephone call.

11. The non-transitory computer-readable recording medium according to claim 6, wherein the information of the telephone call comprises an attribute of the user, and the predetermined layout change condition specifies the attribute of the user.

12. The non-transitory computer-readable recording medium according to claim 6, wherein the information of the telephone call comprises content of the telephone call, and the predetermined layout change condition specifies the content of the telephone call.

13. The layout changing device according to claim 2, wherein the change comprises hiding a display field.

14. The layout changing device according to claim 2, wherein the change comprises differing a display mode of a display field.

15. The layout changing device according to claim 2, wherein the change comprises differing a position of a display field.

16. The layout changing device according to claim 7, wherein the attribute of the user is based in part on at least one of whether the user is experienced or inexperienced, an incoming number, a sex, a department the user belongs to, years of experience, a job title, whether or not the user is a remote worker, or whether or not the user uses a free address system.

17. The layout changing device according to claim 8, wherein the content of the telephone call is based in part on at least one of a call reason for the telephone call, a state, whether the telephone call is inbound or outbound, whether or not the telephone call is internal, a telephone number of the customer, contents of a previous response to the customer, whether or not a specific word is detected, a call start time of the telephone call, or a duration from the call start time.
